(19) United States
(12) Patent Application Publication
(10) Pub. No.: US 2026/0150034 A1
(43) Pub. Date: May 28, 2026

(54) UNIFIED DATA REPOSITORIES AND UNIFIED DATA MANAGEMENT FUNCTIONS

(71) Applicant: Telefonaktiebolaget LM Ericsson (publ), Stockholm (SE)

(72) Inventors: Emiliano MERINO VAZQUEZ, Madrid (ES); David CASTELLANOS ZAMORA, Madrid (ES); Jésus Ángel DE GREGORIO RODRIGUEZ, Madrid (ES); Maria Cruz BARTOLOME RODRIGO, Madrid (ES); Jose Miguel DOPICO, Madrid (ES)

(21) Appl. No.: 19/121,281

(22) PCT Filed: Oct. 23, 2023
(86) PCT No.: PCT/EP2023/079484

§ 371 Date: Apr. 15, 2025

(30) Foreign Application Priority Data
Oct. 28, 2022 (EP) 22383045.6

(51) Int. Cl. H04W 48/16; H04W 48/08; H04W 60/04

(52) U.S. Cl. CPC H04W 48/16; H04W 48/08; H04W 60/04

(57) ABSTRACT

Techniques, apparatuses, and systems for facilitating efficient use of Unified Data Management functions, UDMs, and Unified Data Repositories, UDRs, that support centralized storage of any-UE-data related to a network service, where any-UE-data is data relating to service requests for the network service for all user equipments, UEs, in a wireless network. An example method, in a network exposure function, NEF, in a wireless network, includes discovering one or more UDMs that support centralized storage of any-UE-data related to a network service. The example method further includes, responsive to discovering the one or more UDMs, sending, to only one UDM among the discovered UDMs, a request for subscription to the network service.

### TECHNICAL FIELD

The present disclosure is generally related to wireless telecommunications networks and is more particularly related to wireless telecommunications networks employing unified data repositories (UDRs) and unified data management functions (UDMs) providing storage of subscription-related data for network services.

### BACKGROUND

Recent standards for wireless networks provide for exposure of network services to third party developers and enterprises, so that these third parties can provide enhanced services, building on wireless network services, to their customers. In networks operating under standards developed by the 3rd-Generation Partnership Project (3GPP), this is facilitated by a Network Exposure Function (NEF) provided in the network, which exposes core network capabilities to the third parties. These NEFs may also provide security when these services or Application Functions (AFs) in the network access core network nodes.

To put this in context, in FIG. 1, reference number 1 indicates a reference architecture for a fifth generation, 5G, system. The 5G system architecture is built around a Service-Based Architecture (SBA) paradigm. That is, the different functional components are defined as services, which are self-contained functionalities that can be changed and modified in an isolated manner, without affecting others. The 5G System architecture may comprise the following network functions (NFs):
User Equipment (UE) 2
(Radio) Access Network ((R)AN) 3
User plane Function (UPF) 4
Data network (DN) 5, providing, e.g., operator services, Internet access or 3rd party services
Authentication Server Function (AUSF) 6
Core Access and Mobility Management Function (AMF) 7
Session Management Function (SMF) 8
Application Function (AF) 9
Unified Data Management function (UDM) 13
Policy Control function (PCF) 10
NF Repository Function (NRF) 11
Network Exposure Function (NEF) 12
Unified Data Repository (UDR) 24
Network Slice Selection Function (NSSF), not shown
Structured Data Storage network function (SDSF), not shown,
Unstructured Data Storage network function (UDSF), not shown.

The functional description of each of these network functions is specified in clause 6 of the 3GPP technical standard 23.501 V18.3.0, “System Architecture for the 5G system”, the contents of which are included herein, by reference. In such a service-based communication architecture network, services may invoke procedures such as, but not limited to, an attach procedure, a service request procedure, handover procedure etc., that involve different NFs, and communicate with other services using messages.

Specifically, in FIG. 1, reference numeral 1 indicates the system architecture for a 5G telecommunication network in a roaming case. That is, the UE 2 is not in the telecommunication network where it originally belongs to, i.e., in which the UE 2 is registered. The UE 2 is originally registered with a home network 16, but is presently located in a visited network 15. Such a representation is shown merely for illustrative purposes and is not a limitation of the teachings according to the present disclosure.

Recent standards for wireless networks provide for exposure of network services to third party developers and enterprises, so that these third parties can provide enhanced services, building on wireless network services, to their customers. In 5G networks operating under standards developed by the 3rd-Generation Partnership Project (3GPP), this is facilitated by a Network Exposure Function (NEF) provided in the network, which exposes core network capabilities to the third parties. These NEFs may also provide security when these services or Application Functions (AFs) in the network access core network nodes.

According to 3GPP TS 29.522, v. 17.7.0, which defines application program interfaces (APIs) for the 5G NEF:

The Network Exposure Function (NEF) is a functional element that supports the following functionalities:
The NEF shall securely expose network capabilities and events provided by 3GPP NFs to AF.
The NEF shall provide means for the AF to securely provide information to 3GPP network and may authenticate, authorize and assist in throttling the AF.
The NEF shall be able to translate the information received from the AF to the one sent to internal 3GPP NFs, and vice versa.
The NEF shall support to expose information (collected from other 3GPP NFs) to the AF.
The NEF may support a PFD Function which allows the AF to provision PFD(s) and may store and retrieve PFD(s) in the UDR. The NEF further provisions PFD(s) to the SMF.
The NEF may support the time synchronization exposure function to the AF.
The NEF may provide means for the AF to influence access and mobility management related policies.
The NEF may provide means for the AF to provide inputs that can be used by the PCF for deciding access and mobility management related policies.
The NEF may provide means for the AF to provide the EAS Deployment information.
The NEF may provide means for the AF to retrieve AF specific UE ID.
The NEF may provide means for an untrusted event consumer AF to perform Media Streaming Event Exposure monitoring.

A specific NEF instance may support one or more of the functionalities described above and consequently an individual NEF may support a subset of the APIs specified for capability exposure.

The 5G Unified Data Repository (UDR) stores data used by a variety of 5G NFs, in these categories:
Subscription Data;
Policy Data;
Structured Data for Exposure;
Application Data.

FIG. 2, which is taken from 3GPP TS 23.501, shows the data storage architecture 200 for 5G. Subscription data 210, which may be specific to a UE or group of UEs, is made available to NFs via the Unified Data Management function (UDM) 220, which serves as a front-end to NFs that control the UE's activities within the network, such as the AMF, SMF, and AUSF. (The term “Unified Data Manager” may also be used to refer to a Unified Data Management function—these terms should be considered synonymous, and both may correspond to the abbreviation “UDM.”) The UDR 240 provides policy data 250 directly to the PCF 230. Application data 260 is placed into the UDR 240 by the external AFs, via the Network Exposure Function (NEF) 270, in order to be made available to authorized 5G NFs that need subscriber-related information.

UDRs may be deployed in a distributed fashion. 3GPP TS 23.501 states:
There can be multiple UDRs deployed in the network, each of which can accommodate different data sets or subsets, (e.g. subscription data, subscription policy data, data for exposure, application data) and/or serve different sets of NFs. Deployments where a UDR serves a single NF and stores its data, and, thus, can be integrated with this NF, can be possible.

Thus, a UDR can store data for a particular set of UEs. Separate UDRs may be used for different customers, or network slices, for example, to allow for isolation of data resources between different companies. 3GPP TS 23.501 also specifies that:
UDR can be deployed in each PLMN [Public Land Mobile Network] and it can serve different functions as follows:
   UDR accessed by the NEF belongs to the same PLMN where the NEF is located.
   UDR accessed by the UDM belongs to the same PLMN where the UDM is located if UDM supports a split architecture.
   UDR accessed by the PCF belongs to the same PLMN where the PCF is located.

The Network Exposure Function (NEF) may wish to subscribe to events (event exposure) that shall be detected and reported for all UEs in the PLMN, i.e., for any UE in the PLMN. The network may be segmented in different user ranges, which means that if a request is intended to target all UEs, it must be applied/configured in every network segment, i.e., in all Unified Data Manager/Unified Data Repository (UDM/UDR) groups that are managing sets of users.

3GPP has defined a procedure to manage requests targeting all UEs (any UE), rather than a particular UE or group of UEs. This can be seen in 3GPP TS 29.503 V18.3.0, annex B (from FIG. B-4):
2. The NEF discovers (by means of NRF query) all UDM instances supporting the required service (e.g. nudm-ee). The NEF selects an UDM instance (e.g., UDM 1) from each UDM Group ID discovered (UDM 1 and UDM 2 are in the same UDM Group ID) and sends the subscribe request. The NEF also stores the UDM Group ID information to select a UDM for subsequent subscriptions.

Therefore, each UDM selected will store the subscription request data in its UDR (it is assumed that the UDM and the UDR have a 1:1 relationship, meaning that each related UDM/UDR group manages the same set of users). If a 1:1 relationship does not exist (N:1 UDM−>UDR), the UDM would store the same data N times in the same UDR (see FIG. 2). This results in each UDR group storing the same exact subscription request, resulting in that all UDR groups have replicated information that is applicable to all UEs, no matter the UE segmentation and the number of UDM/UDR groups.

This is shown in FIG. 3 which is a signalling diagram illustrating the signalling between a UDM-1 and UDR-1 in Group-A, a UDM-2 and a UDR-2 in Group-B, a NEF and an AF. Step 1 of FIG. 3, corresponds to the existence of a pre-condition in which the AF subscribes to an event targeting any UE (e.g. all UEs in the network). In Step 2 of FIG. 3, the NEF discovers UDMs and selects one UDM instance from each UDM group to target all UEs (in this example UDM-1 in Group-A and UDM-2 in Group-B). Step 3 is the sending of a Nudm_EventExposure_Subscribe request (any UE, event type) from the NEF to UDM-2. In step 4, UDM-2 stores the event subscription in its UDR (i.e. UDR-2). Step 5 is the sending of a Nudm_EventExposure_Subscribe request (any UE, event type) from the NEF to UDM-1. In step 6, UDM-1 stores the event subscription in its UDR (i.e. UDR-1). The final step indicates the problem that the same subscription is replicated in all UDRs/UDR groups, which leads to inefficient storage and footprint.

It has recently been proposed in 3GPP to add the possibility to configure a specific UDR group (central UDR group/common UDR group) to store all data related to any UE, referred to as “any-UE data” or “data for AnyUE” herein, and thus avoid replication of data storage in all UDR groups. This way, the operator can select a UDR group and configure its NF profile to indicate that only those UDRs belonging to the (central) UDR group shall have the any-UE data stored. This solves the problem of having multiple UDRs storing the same exact data, but still it does not solve the problem of having the same data replicated. This is seen in FIG. 4. Since UDMs do not communicate with each other (they are stateless/data-less), all UDMs will store the data in the same UDR group. Hence, the same UDR will have as many copies of the stored data as UDM groups are deployed in the network.

FIG. 4 is a signalling diagram illustrating the signalling between a UDR that is for any UE, a UDM-1 in Group-A, a UDM-2 in Group-B, a NEF and an AF. Step 1 of FIG. 4, corresponds to the existence of a pre-condition in which the AF subscribes to an event targeting any UE (e.g. all UEs in the network). In Step 2 of FIG. 4, the NEF discovers UDMs and selects one UDM instance from each UDM group to target all UEs (in this example UDM-1 in Group-A and UDM-2 in Group-B). Step 3 is the sending of a Nudm_EventExposure_Subscribe request (any UE, event type) from the NEF to UDM-1. In step 4, UDM-1 discovers UDRs which are configured to store any UE (e.g. all UEs) data, and then stores the event subscription in the selected (central) UDR. In step 5 the NEF sends a Nudm_EventExposure_Subscribe request (any UE, event type) to UDM-2. In step 6, UDM-2 discovers UDRs which are configured to store any UE (e.g. all UEs) data, and then stores the event subscription in the selected (central) UDR. The final step indicates the problem that although the same event subscription is not replicated in all UDRs/UDR groups, it is still replicated in the same UDR group, since all UDM groups are storing it in the same UDR group.

### SUMMARY

One possible solution to the replication problems described above might be based on NEF local policy. That is, when the operator decides to configure a UDR group to host/store data related to any UE (all UEs) and upgrades the UDMs to support this network configuration, the NEF could be expressly configured to select a single UDM (in a single group) and send the request to the selected UDM, regardless of the number of UDM groups in the network. This is not a good solution, however, since the operator is forced to have the configuration in UDRs and NEFs simultaneously done, to avoid transient scenarios in which UDRs are already central and yet the NEF still performs forking of requests towards all UDM groups.

It is required then to have this defined by software and follow “zero-touch” procedures, i.e., as soon as the UDRs/UDMs are upgraded and the configuration to have a central UDR group is performed, new requests would immediately work consistently, without a need for re-configuring the rest of network functions (e.g., NEF).

These problems are addressed herein with techniques, apparatuses, and systems for facilitating efficient use of Unified Data Managers (UDMs) and Unified Data Repositories (UDRs) that support centralized storage of any-UE-data related to a network service, where any-UE-data is data relating to service requests for the network service for all user equipments (UEs) in a wireless network.

According to these techniques, the NEF is assisted to determine whether forking of requests to multiple UDMs (one UDM in each UDM Group) is required. This is done by discovering: 1) whether UDR is configured to store data for AnyUE (based on new data in UDR profile); and 2) whether the UDMs support the deployment of UDR for AnyUE or only forking to one UDM in each UDM Group.

According to some of these new techniques, a new query parameter is defined in the NRF NF_discover service, so that NEF can obtain UDRs storing data for AnyUE for a specific dataset (e.g., subscription-data). Likewise, a new UDM supported-feature (UDR centralized any-UE data) is defined in UDM services (e.g., nudm-ee) so that NEF can identify UDMs capable of routing requests targeting any UE towards a central UDR group.

This way, with a combination of deployment configuration in UDRs and the routing capabilities in UDM, NEF can determine whether all UDM groups are to be contacted, or only one UDM group is required (because such UDM group will store the data in a central UDR and it will be accessible by all UDMs).

A first example method, in a network exposure function (NEF) in a wireless network, comprises the step of discovering one or more UDMs in the wireless network that support centralized storage of any-UE-data related to a network service. The example method further comprises, responsive to discovering the one or more UDMs, sending, to only one UDM among the discovered UDMs, a request for subscription to the network service. In some embodiments, the method further comprises discovering at least one UDR in the wireless network that is configured for centralized storage of any-UE-data, where the sending of the request is responsive to discovering both the one or more UDMs and the at least one UDR. In some embodiments, the wireless network comprises a plurality of UDMs and a plurality of UDRs.

A second example method, complementing the one above, is implemented in a network repository function (NRF) configured to provide service registration in a wireless network. This example method comprises the step of receiving, from a NEF configured to expose services of the wireless network to one or more AFs, a discovery request message for UDMs in the wireless network that support centralized storage of any-UE-data related to a network service, where any-UE-data is data relating to service requests for the network service for all UEs in the wireless network. This example method further comprises identifying one or more UDMs that support centralized storage of any-UE-data related to that network service, and responding to the NEF with a message indicating the identified one or more UDMs. In some embodiments, the wireless network comprises a plurality of UDMs and a plurality of UDRs.

A complementary third method described below is carried out in a UDM, where the method comprises sending, to an NRF, a registration message indicating the support of centralized storage of any-UE-data related to the network service.

A complementary fourth method described below is carried out in a UDR in a wireless network having an NEF configured to expose services of the wireless network to one or more AFs. This example method comprises sending, to an NRF, a registration message indicating the support of centralized storage of any-UE-data related to the network service. Any-UE-data is data relating to service requests for the network service for all UEs in the wireless network. In some embodiments, the UDM can send a registration message to an NRF for each of one or more network services.

A first example network node or combination of network nodes is configured to act as an NEF, and thus to expose services of a wireless network to one or more AFs in a wireless network. This first example of a network node or combination of network nodes is configured or adapted to carry out a method according to the first example method.

A second example network node or combination of network nodes is configured to act as an NRF configured to provide service registration in a wireless network. This second example network of a node or combination of network nodes is configured or adapted to carry out a method according to the second example method.

A third example network node or combination of network nodes is configured to operate as a UDM in a wireless network having an NEF configured to expose services of the wireless network to one or more AFs. This third example of a network of a node or combination of network nodes is configured or adapted to carry out a method according to the third example method.

A fourth example network node or combination of network nodes is configured to operate as a UDR in a wireless network having an NEF configured to expose services of the wireless network to one or more AFs. This fourth example of a network of a node or combination of network nodes is configured or adapted to carry out a method according to the fourth example method.

A first example computer program product comprises program instructions for execution by a processing circuit in a network node or combination of network nodes. The program instructions are configured to cause the network node or combination of network nodes to carry out a method according to any one of the example methods discussed above.

A first example computer-readable medium, such as a non-transitory computer-readable medium, comprises the first example computer program product.

The disclosed techniques allow the NEF and any NF or NF service consumer (NFc) to be aware of the data storage and routing related to any UE/all UEs, so that this information influences its behavior. For instance, if there is no central UDR configured or the UDM does not have the routing capabilities required, the NEF will target one UDM within each group; otherwise, if both conditions are met, the NEF can simply select a single UDM to send a request for any-UE data.

### BRIEF DESCRIPTION OF THE FIGURES

FIG. 1 is a block diagram illustrating a reference architecture for a 5G system.

FIG. 2 illustrated the 5G core network data storage architecture.

FIG. 3 illustrates storage of subscription request data in UDRs, according to previous techniques.

FIG. 4 is a signal flow diagram illustrating configuration of a UDR group to store any-UE-data.

FIG. 5 is a signal flow diagram illustrating an example solution according to techniques disclosed herein.

FIG. 6 is a process flow diagram illustrating an example method according to some embodiments.

FIG. 7 is a process flow diagram showing another example method, according to some embodiments.

FIG. 8 and FIG. 9 are each process flow diagrams showing other example methods, according to some embodiments.

FIG. 10 illustrates components of an example communication system.

FIG. 11 shows an example user equipment (UE).

FIG. 12 illustrates an example network node, according to some embodiments.

FIG. 13 shows an example host node, according to some embodiments.

FIG. 14 illustrates a virtualization environment.

FIG. 15 illustrates communications between a UE, a network node, and a host node.

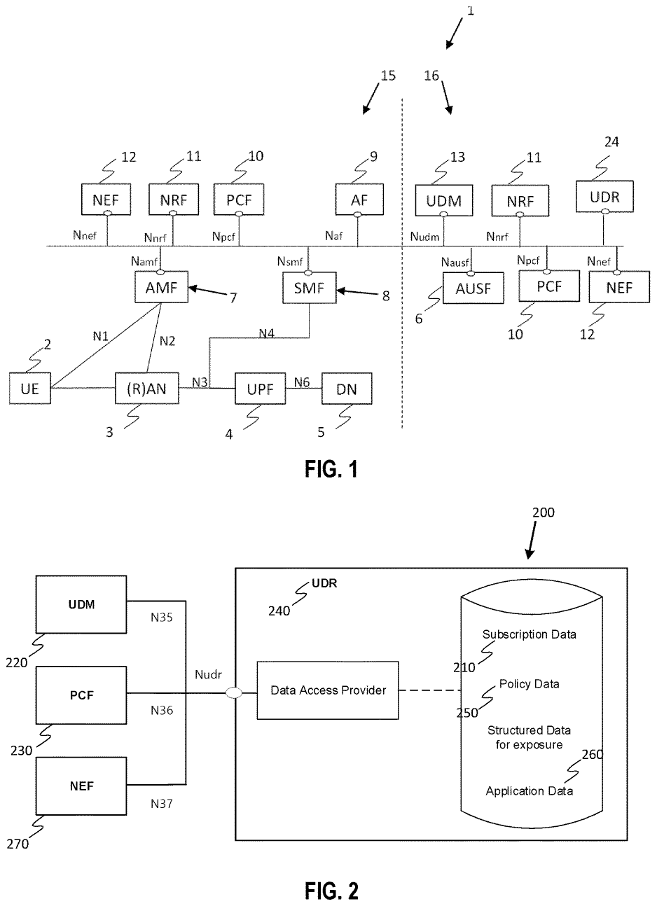

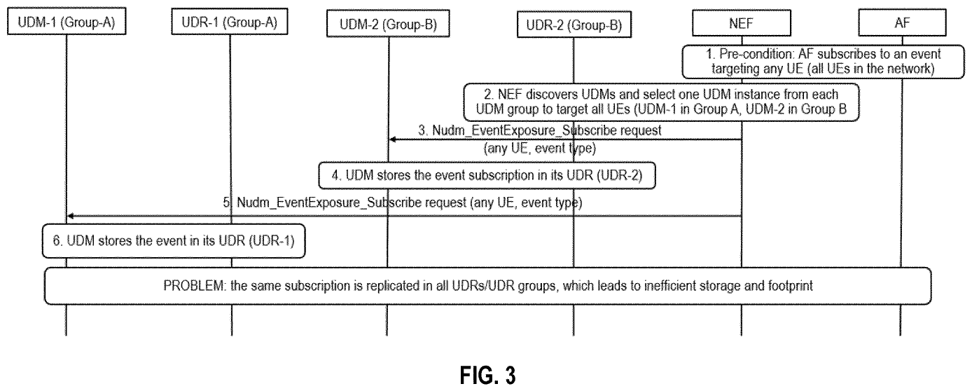

### DETAILED DESCRIPTION

As suggested above, the techniques described herein avoid unnecessary replication of network exposure data (e.g., event exposure subscriptions) in different UDRs or in the same UDR, by following a “zero-touch” goal. That is, NEF (or any 5GC NF consumer) can automatically, i.e., with software-defined mechanisms that require no manual configuration, determine how requested towards UDMs are to be managed. This gets rid of (manual) configuration where each and every UDM service consumer (NFc, e.g., NEF) must be configured with “no-forking required” for requests targeting any UE.

According to embodiments described herein, a UDR configuration for AnyUE, as disclosed in 3GPP document, C4-224117 (available at

www.3gpp.org/ftp/tsg_ct/WG4_protocollars_ex-CN4/TSGCT4_111e_meeting/docs/C4-224117.zip) is extended with a service name, so that the centralization of UDR for the AnyUE feature may apply only for certain services. This allows that for some services centralization in only one UDR is configured, while for others replication in all “local” UDRs may be preferable. For example, when a UE terminal's SW version is modified, this requires that IMEI is modified for all the subscribers, then it may be optimal to keep the subscription data replicated in all the UDRs to minimize the signaling in these cases. For other services, like application data, it may be preferable to deploy a central UDR, so as to avoid data replication in all UDRs. The techniques described herein facilitate this service-specific distinction.

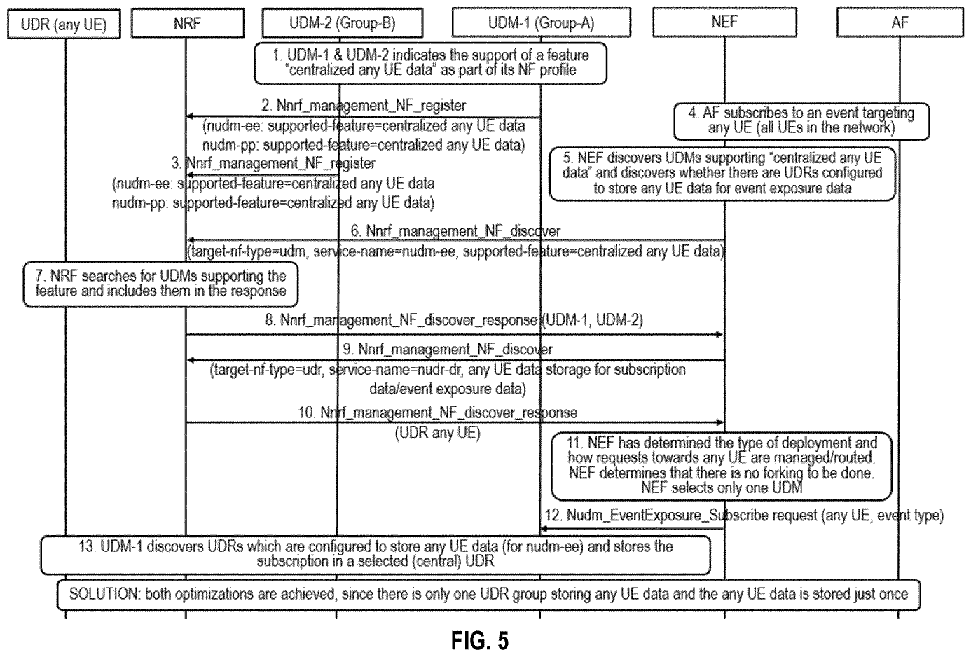

FIG. 5 illustrates a detailed example of the solution, and in particular shows the signalling between an a UDM-1 in Group-A, a UDM-2 in Group-B, a UDR (for any UE), a NEF and an AF. This example assumes that the UDR is registered with an indication of any UE. This anyUE flag may be defined on a per-service basis—in the illustrated example, it will apply to both nudm-ee and nudm-pp services.

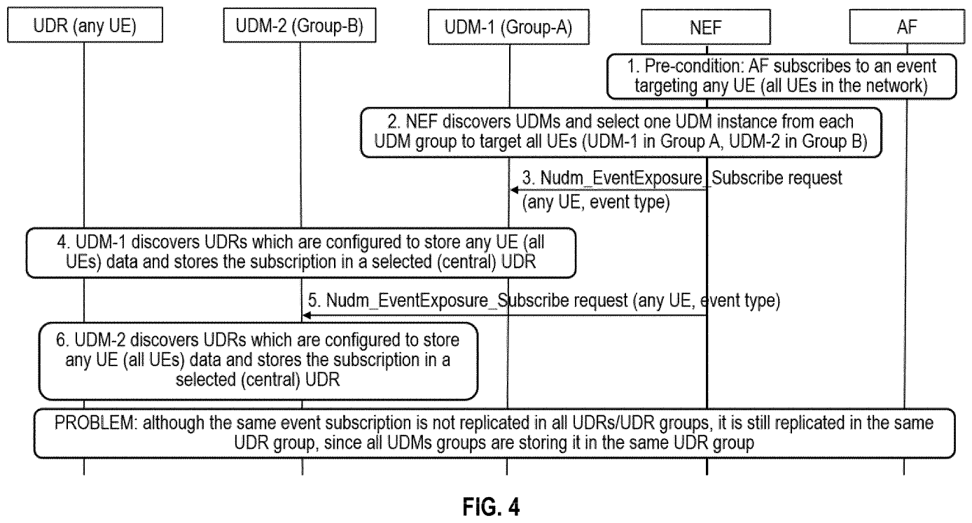

Step 1 of FIG. 4, corresponds to the existence of a pre-condition in which the AF subscribes to an event targeting any UE (e.g. all UEs in the network). In Step 2 of FIG. 4, the NEF discovers UDMs and selects one UDM instance from each UDM group to target all UEs (in this example UDM-1 in Group-A and UDM-2 in Group-B). Step 3 is the sending of a Nudm_EventExposure_Subscribe request (any UE, event type) from the NEF to UDM-1. In step 4, UDM-1 discovers UDRs which are configured to store any UE (e.g. all UEs) data, and then stores the event subscription in the selected (central) UDR. In step 5 the NEF sends a Nudm_EventExposure_Subscribe request (any UE, event type) to UDM-2. In step 6, UDM-2 discovers UDRs which are configured to store any UE (e.g. all UEs) data, and then stores the event subscription in the selected (central) UDR. The final step indicates the problem that although the same event subscription is not replicated in all UDRs/UDR groups, it is still replicated in the same UDR group, since all UDM groups are storing it in the same UDR group.

In steps 1-3 of the procedure shown in FIG. 5, each UDM (UDM-1, UDM-2) registers its NF profile in NRF (either at instantiation or after a software upgrade). Here, each UDM registers a new supported feature (“any-UE centralized data” also referred to herein as “centralized any UE data”) for each of one or more related services (e.g., nudm-ee, nudm-pp). This new feature indicates that a request related to the services listed will be stored in a central UDR, if there are UDRs configured to host any-UE data for these services. Again, for the purposes of this document, the term “any-UE data” refers to data relating to service requests for a network service for all UEs in the wireless network or network slice.

For example, in step 1, UDM-1 (of group-A) and a UDM-2 (of group-B) may indicate the support of a feature “centralized any UE data” as part of its NF profile in service nudm-ee, nudm-pp, etc. The feature may indicate their capability to store and manage data related to any UE in those UDRs configured for any UE storage.

In step 2, UDM-1 may send, to the NRF, Nnrf_management_NF_register (e.g., including nudm-ee: supported-feature=centralized any UE data, nudm-pp: supported-feature=centralized any UE data). In step 3, UDM-2 may send, to the NRF, Nnrf_management_NF_register (e.g., including nudm-ee: supported-feature=centralized any UE data, nudm-pp: supported-feature=centralized any UE data).

Note that by storing the data in a central UDR, data will be accessible to all UDMs (UDM groups) in the network that support this routing capability, so the NF consumer needs only to contact one UDM supporting the feature.

A special case (not described in the figure), is also possible. In the unlikely case that in the network it is possible to have UDM groups supporting the new feature and UDM groups not supporting the feature, the NEF needs to discover all the UDR Groups, check the feature support, and then NEF will fork the requests to those UDM groups not supporting the feature, in addition to sending it to only one of the UDMs that do support the feature.

At step 4 in the procedure shown in FIG. 5, the AF subscribes to an event targeting any UE, so that the event is detected and reported for all UEs in the network. At steps 5-10, e.g., in response to receiving this subscription request, the NEF performs two discoveries towards NRF. First is UDM discovery, whereby the NEF discovers (via the NRF), UDMs supporting the new feature (centralized-any-ue-data for nudm-ee). Note that by “discovery” is simply meant that one or more messages or requests are sent to the NRF, requesting (implicitly or explicitly) information regarding the availability of UDMs that support the new feature. These messages or requests may be service-specific, e.g., by including one or more parameters, specific to a certain service or group of services, indicating this request.

This first discovery can comprise the NEF transmitting, to the NRF, Nnrf_management_NF_discover (e.g., including target-nf-type=udm, service-name=nudm-ee, supported-feature=centralized any UE data) (see signal 6). In step 7, the NRF may then search for UDMs supporting the feature “centralized any UE data” and include them in a response. For example, with this response, shown as signal 8, the NRF may send, to the NEF, Nnrf_management_NF_ discover_response (e.g., including UDM-1, UDM-2).

If UDMs are returned, the NEF proceeds with the second discovery—UDR discovery. The NEF discovers UDRs, again via the NRF, which are configured as “central”, i.e. configured to store any UE data for event exposure data (subscription data). It is possible to discover “central UDR” for the requested data-set (e.g. subscription data), that is, to discover the specific UDR that is configured to store data applicable to “any UE,” for the related data-set.

For example, the NEF may send, to the NRF, Nnrf_management_NF_discover (e.g., including target-nf-type=udr, service-name=nudr-dr, any UE data storage for subscription data/event exposure data), as shown by signal 9. The NRF may send, to the NEF, an Nnrf_management_NF_discover_response (e.g., including UDR any UE), as shown by signal 10.

Note that alternatively, the NEF can discover all UDMs and UDRs in the network, without any filtering criteria, and cache the result, i.e., locally store the result. This way, NEF can subsequently check the locally cached UDM/UDR profiles, which contain both the UDM new supported feature and the UDR NF profile configuration, to identify the appropriate UDMs and UDR.

As an alternative, it is possible that the NEF may be configured to simply assume that, if there are one or more UDM instances supporting centralized any-UE-data storage, than there is at least one UDR that is appropriately configured. In this case, the second discovery step may be omitted.

In step 11, the NEF is able to determine, based on the UDR and UDM NF profiles, the type of deployment and how requests towards any UE are managed/routed. The NEF then determines whether forking is required, that is, whether a UDM within each group needs to be contacted, based on the NRF responses (or NF profiles previously cached). For example, it may be determined that there is no forking to be done (i.e., any UDM selected will store the data in a central UDR for any UE so that it is accessible for all UDM groups). If both conditions are met (UDM routing capabilities to store data in the UDR and UDR configuration to store data in a central manner), the NEF selects a single (i.e. only one) UDM instance (e.g., based on NEF locality and UDM priorities in the NF profile) to which to send the request. In this case, at step 11, both conditions are met, and only one UDM is contacted, as shown by signal 12, where the NEF sends, to UDM-1, Nudm_EventExposure_Subscribe request (e.g., including any UE, event type).

As shown at step 13, this UDM (UDM-1) discovers the central UDR for the corresponding service and then sends the requests to this central UDR. That is, UDM-1 discovers UDRs which are configured to store any UE data (for nudm-ECG electrodes 9) and stores the subscription in a selected (central) UDR.

This way, there is no need to locally configure each and every UDM NF consumer (e.g., NEF), since it is all done via software by discovering the type of deployment by UDM service consumers. Thus, in this way, both optimizations are achieved since there is only one UDR group storing any UE data and the “any UE data” is stored just once, since the NEF determined the type deployment based on how the UDR is configured, and how the UDM manages the “any UE data”.

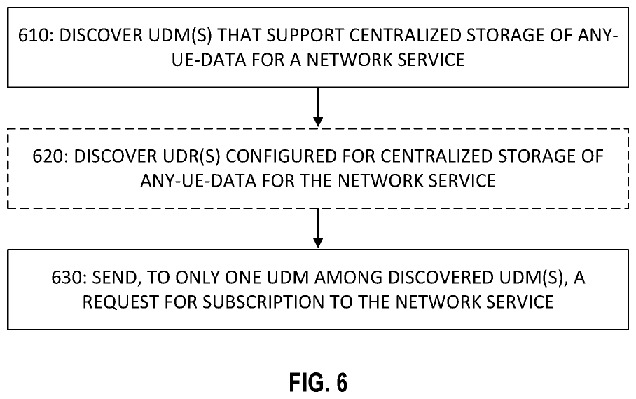

FIG. 6 is a process flow diagram illustrating an example method according to some of the techniques described above, as implemented in an NEF configured to expose services of a wireless network to one or more AFs, where the wireless network comprises a plurality of UDMs and a plurality of UDRs. Note that the method as illustrated in FIG. 6 and as described below is intended to be a generalization of and to include at least some of the techniques described above, and thus where different terms above and in the description below are used, the terms below should be understood to be at least as broad, and to encompass, the similar terms used above.

As shown at block 610, the method comprises the step discovering one or more UDMs that support centralized storage of any-UE-data related to a network service, where any-UE-data is data relating to service requests for the network service for UEs in the wireless network. Here, the term “the network service” may refer to a specific network service—as noted above, a “AnyUE” flag in a UDM or UDR configuration may be service-specific.

As shown at block 620, the method further comprises the step of discovering at least one UDR that is configured for centralized storage of any-UE-data for the network service.

As an alternative, it is possible that the NEF may be configured to simply assume that, if there are one or more UDM instances supporting centralized any-UE-data storage, than there is at least one UDR that is appropriately configured. In this case, the second discovery step may be omitted.

As shown at block 630, the method still further comprises, responsive to the discovering of the one or more UDMs and (in some embodiments) the at least one UDR, sending, to only one UDM among the discovered UDMs that support centralized storage of any-UE-data related to the network service, a request for subscription to the network service. Thus, the process illustrated in FIG. 6 assumes that the NEF is successful in finding a UDM and UDR that support the any-UE data feature—otherwise, the NEF will use previously disclosed techniques to “fork” its request to multiple UDMs/UDRs.

The network service to which the any-UE data feature pertains may be any one of various network services, such as an event exposure service. The request for a subscription to this network service, shown at block 630, may then be for all UEs in the wireless network, for that service.

In some embodiments of the method illustrated in FIG. 6, discovering one or more UDMs that support centralized storage of any-UE-data related to the network service comprises sending, to an NRF, a discovery request message comprising a parameter, specific to the network service, indicating a request for a centralized any-UE-data management feature for the network service. Similarly, discovering at least one UDR that is configured for centralized storage of any-UE-data may comprise sending, to an NRF, a discovery request message comprising a parameter, specific to the network service, indicating a request for a centralized any-UE-data storage feature for the network service.

In some embodiments of the method illustrated in FIG. 6, discovering one or more UDMs that support centralized storage of any-UE-data related to the network service may instead comprise evaluating a locally-stored set of profiles for UDMs in the network to identify one or more UDMs that support centralized storage of any-UE-data related to the network service. Similarly, discovering at least one UDR that is configured for centralized storage of any-UE-data may comprise evaluating a locally-stored set of profiles for UDRs in the network to identify one or more UDRs configured for centralized storage of any-UE-data related to the network service.

In some embodiments, the method may comprise selecting the only one UDM, to which the request for subscription is sent, based on locations of the discovered UDMs and/or based on predetermined prioritizations of the discovered UDMs.

As noted above, the process flow illustrated in FIG. 6 assumes that at least one UDM/UDR group that supports the features described herein is discovered. It may also be the case, however, that the network includes one or more UDM groups that include no UDMs supporting centralized storage of any-UE-data related to the network service. Thus, in some embodiments or instances of the method illustrated in FIG. 6, the method may further comprise determining that the network includes one or more UDM groups that include no UDMs supporting centralized storage of any-UE-data related to the network service, and sending, to at least one UDM in each of the one or more UDM groups that include no UDMs supporting centralized storage of any-UE-data related to the network service, a request for subscription to the network service.

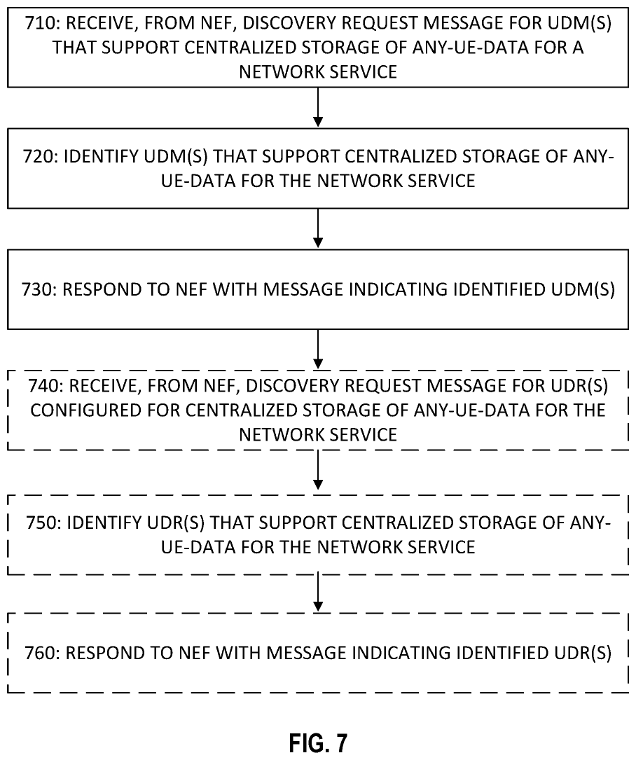

FIG. 7 is a process flow diagram illustrating an example method, in an NRF configured to provide service registration in a wireless network, where the wireless network comprises a UDMs and a plurality of UDRs. This example method complements the method shown in FIG. 6 and, like the method shown in FIG. 6, is intended to be a generalization of and to include at least some of the techniques described above, so that where different terms above and in the description below are used, the terms below should be understood to be at least as broad, and to encompass, the similar terms used above.

The method of FIG. 7 includes, as shown at block 710, the step of receiving, from an NEF, configured to expose services of the wireless network to one or more AFs, a discovery request message for UDMs that support centralized storage of any-UE-data related to a network service. As elsewhere herein, the term any-UE-data refers to data relating to service requests for the network service for all UEs in the wireless network.

The method further comprises, as shown at block 720, identifying one or more UDMs that support centralized storage of any-UE-data related to that network service. The method still further comprises the step of responding to the NEF with a message indicating the identified one or more UDMs, as shown at block 730.

In some embodiments or instances, the method comprises receiving, from the NEF, a discovery request message for at least one UDR that is configured for centralized storage of any-UE-data related to the network service. This is shown at block 740. In these embodiments or instances, the method may further comprise the steps of identifying at least one UDR that supports centralized storage of any-UE-data related to that network service and responding to the NEF with a message indicating the identified at least one UDR, as shown at block 750 and 760.

In some embodiments or instances, the method may comprise, prior to receiving the discovery request message or messages mentioned above, a registration message from each of one or more UDMs and/or UDRs that support centralized storage of any-UE-data related to the network service, where each registration message indicates the support of centralized storage of any-UE-data related to the network service.

As discussed above, the network service may be any of a variety of network services, such as an event exposure service. Using 3GPP terminology, the service may be any Nudm service used by the NEF (e.g., for Exposure, Parameter Provisioning).

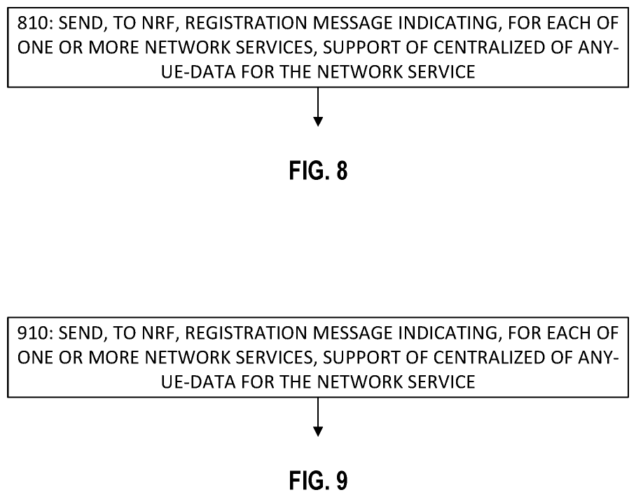

FIG. 8 illustrates a complementary method implemented in a UDM configured to manage a UDR in a wireless network having an NEF configured to expose services of the wireless network to one or more AFs, where the wireless network comprises a plurality of UDMs and a plurality of UDRs. This example method comprises, as shown at block 810, the step of sending, to a Network Repository Function, a registration message indicating, for each of one or more network services, the support of centralized storage of any-UE-data related to the network service, where any-UE-data is data relating to service requests for the network service for all UEs in the wireless network.

Likewise, FIG. 9 illustrates a similar method implemented in a UDR, where block 910 illustrates the step of sending, to a Network Repository Function, a registration message indicating, for each of one or more network services, the support of centralized storage of any-UE-data related to the network service, where any-UE-data is data relating to service requests for the network service for all UEs in the wireless network.

In either case, the one or more network services may comprise, for example, any one or more of: an event exposure service, a parameter provisioning service, and a service parameter service.

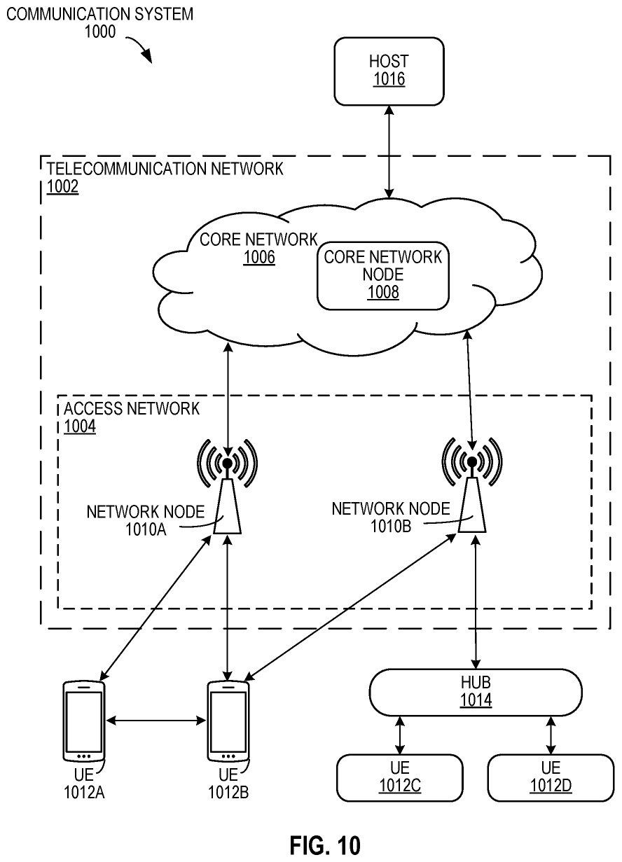

FIG. 10 shows an example of a communication system 1000 in accordance with some embodiments. The techniques detailed herein may be implemented in one or nodes of this or a similar communication system, or in nodes connected to or otherwise associated with this or a similar communication system.

In the example, the communication system 1000 includes a telecommunication network 1002 that includes an access network 1004, such as a radio access network (RAN), and a core network 1006, which includes one or more core network nodes 1008. The access network 1004 includes one or more access network nodes, such as network nodes 1010a and 1010b (one or more of which may be generally referred to as network nodes 1010), or any other similar 3rd Generation Partnership Project (3GPP) access node or non-3GPP access point. The network nodes 1010 facilitate direct or indirect connection of user equipment (UE), such as by connecting UEs 1012a, 1012b, 1012c, and 1012d (one or more of which may be generally referred to as UEs 1012) to the core network 1006 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1000 may include any number of wired or wireless networks, network nodes, UEs, and/or any other components or systems that may facilitate or participate in the communication of data and/or signals whether via wired or wireless connections. The communication system 1000 may include and/or interface with any type of communication, telecommunication, data, cellular, radio network, and/or other similar type of system.

The UEs 1012 may be any of a wide variety of communication devices, including wireless devices arranged, configured, and/or operable to communicate wirelessly with the network nodes 1010 and other communication devices. Similarly, the network nodes 1010 are arranged, capable, configured, and/or operable to communicate directly or indirectly with the UEs 1012 and/or with other network nodes or equipment in the telecommunication network 1002 to enable and/or provide network access, such as wireless network access, and/or to perform other functions, such as administration in the telecommunication network 1002.

In the depicted example, the core network 1006 connects the network nodes 1010 to one or more hosts, such as host 1016. These connections may be direct or indirect via one or more intermediary networks or devices. In other examples, network nodes may be directly coupled to hosts. The core network 1006 includes one more core network nodes (e.g., core network node 1008) that are structured with hardware and software components. Features of these components may be substantially similar to those described with respect to the UEs, network nodes, and/or hosts, such that the descriptions thereof are generally applicable to the corresponding components of the core network node 1008. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Unified Data Repository (UDR), Application Function (AF), Network Repository Function (NRF), Security Edge Protection Proxy (SEPP), Network Exposure Function (NEF), and/or a User Plane Function (UPF). In some embodiments, a core network node may comprise an NWADF configured to operate according to various ones of the techniques described herein. Likewise, one or more core network nodes may be configured to operate as a consumer of network analytics, according to any of the techniques described herein—examples of such a core network node might include an AMF, SMF, Network Repository Function (NRF), or Policy Control Function (PCF).

The host 1016 may be under the ownership or control of a service provider other than an operator or provider of the access network 1004 and/or the telecommunication network 1002, and may be operated by the service provider or on behalf of the service provider. The host 1016 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1000 of FIG. 10 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 1102.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1002 is a cellular network that implements 3GPP standardized features. Accordingly, the telecommunications network 1002 may support network slicing to provide different logical networks to different devices that are connected to the telecommunication network 1002. For example, the telecommunications network 1002 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1012 are configured to transmit and/or receive information without direct human interaction. For instance, a UE may be designed to transmit information to the access network 1004 on a predetermined schedule, when triggered by an internal or external event, or in response to requests from the access network 1004. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio—Dual Connectivity (EN-DC).

In the example, the hub 1014 communicates with the access network 1004 to facilitate indirect communication between one or more UEs (e.g., UE 1012c and/or 1012d) and network nodes (e.g., network node 1010b). In some examples, the hub 1014 may be a controller, router, content source and analytics, or any of the other communication devices described herein regarding UEs. For example, the hub 1014 may be a broadband router enabling access to the core network 1006 for the UEs. As another example, the hub 1014 may be a controller that sends commands or instructions to one or more actuators in the UEs.

Commands or instructions may be received from the UEs, network nodes 1010, or by executable code, script, process, or other instructions in the hub 1014. As another example, the hub 1014 may be a data collector that acts as temporary storage for UE data and, in some embodiments, may perform analysis or other processing of the data. As another example, the hub 1014 may be a content source. For example, for a UE that is a VR headset, display, loudspeaker or other media delivery device, the hub 1014 may retrieve VR assets, video, audio, or other media or data related to sensory information via a network node, which the hub 1014 then provides to the UE either directly, after performing local processing, and/or after adding additional local content. In still another example, the hub 1014 acts as a proxy server or orchestrator for the UEs, in particular in if one or more of the UEs are low energy IoT devices.

The hub 1014 may have a constant/persistent or intermittent connection to the network node 1010b. The hub 1014 may also allow for a different communication scheme and/or schedule between the hub 1014 and UEs (e.g., UE 1012c and/or 1012d), and between the hub 1014 and the core network 1006. In other examples, the hub 1014 is connected to the core network 1006 and/or one or more UEs via a wired connection. Moreover, the hub 1014 may be configured to connect to an M2M service provider over the access network 1004 and/or to another UE over a direct connection. In some scenarios, UEs may establish a wireless connection with the network nodes 1010 while still connected via the hub 1014 via a wired or wireless connection. In some embodiments, the hub 1014 may be a dedicated hub—that is, a hub whose primary function is to route communications to/from the UEs from/to the network node 1010b. In other embodiments, the hub 1014 may be a non-dedicated hub—that is, a device which is capable of operating to route communications between the UEs and network node 1010b, but which is additionally capable of operating as a communication start and/or end point for certain data channels.

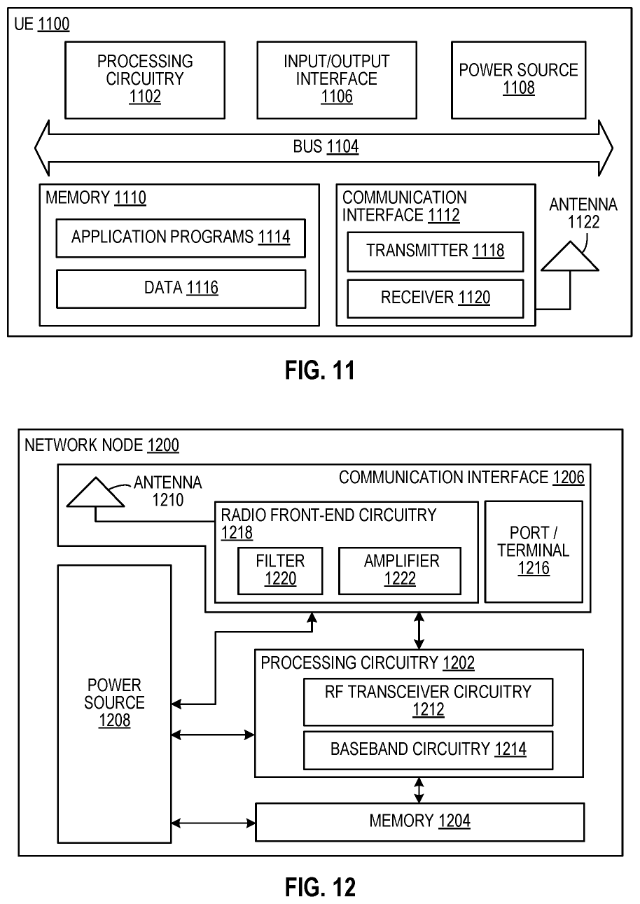

FIG. 11 shows a UE 1100 in accordance with some embodiments. UE 1100 may be the target of a network data analytics request and report, as described above, or may otherwise benefit from the techniques described herein. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1100 includes processing circuitry 1102 that is operatively coupled via a bus 1104 to an input/output interface 1106, a power source 1108, a memory 1110, a communication interface 1112, and/or any other component, or any combination thereof. Certain UEs may utilize all or a subset of the components shown in FIG. 11. The level of integration between the components may vary from one UE to another UE. Further, certain UEs may contain multiple instances of a component, such as multiple processors, memories, transceivers, transmitters, receivers, etc.

The processing circuitry 1102 is configured to process instructions and data and may be configured to implement any sequential state machine operative to execute instructions stored as machine-readable computer programs in the memory 1110. The processing circuitry 1102 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1102 may include multiple central processing units (CPUs).

In the example, the input/output interface 1106 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1100. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1108 is structured as a battery or battery pack. Other types of power sources, such as an external power source (e.g., an electricity outlet), photovoltaic device, or power cell, may be used. The power source 1108 may further include power circuitry for delivering power from the power source 1108 itself, and/or an external power source, to the various parts of the UE 1100 via input circuitry or an interface such as an electrical power cable. Delivering power may be, for example, for charging of the power source 1108. Power circuitry may perform any formatting, converting, or other modification to the power from the power source 1108 to make the power suitable for the respective components of the UE 1100 to which power is supplied.

The memory 1110 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1110 includes one or more application programs 1114, such as an operating system, web browser application, a widget, gadget engine, or other application, and corresponding data 1116. The memory 1110 may store, for use by the UE 1100, any of a variety of various operating systems or combinations of operating systems.

The memory 1110 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1110 may allow the UE 1100 to access instructions, application programs and the like, stored on transitory or non-transitory memory media, to off-load data, or to upload data. An article of manufacture, such as one utilizing a communication system may be tangibly embodied as or in the memory 1110, which may be or comprise a device-readable storage medium.

The processing circuitry 1102 may be configured to communicate with an access network or other network using the communication interface 1112. The communication interface 1112 may comprise one or more communication subsystems and may include or be communicatively coupled to an antenna 1122. The communication interface 1112 may include one or more transceivers used to communicate, such as by communicating with one or more remote transceivers of another device capable of wireless communication (e.g., another UE or a network node in an access network). Each transceiver may include a transmitter 1118 and/or a receiver 1120 appropriate to provide network communications (e.g., optical, electrical, frequency allocations, and so forth). Moreover, the transmitter 1118 and receiver 1120 may be coupled to one or more antennas (e.g., antenna 1122) and may share circuit components, software or firmware, or alternatively be implemented separately.

In the illustrated embodiment, communication functions of the communication interface 1112 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 1102.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1112, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1100 shown in FIG. 11.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 12 shows a network node 1200 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Other examples of network nodes can include nodes in the core network, such as Network Functions, (NFs), including any of Unified Data Management (UDM), Unified Data Repository (UDR), Application Function (AF), Network Repository Function (NRF), and Network Exposure Function (NEF).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs). Some of these and other network nodes, such as the core network nodes discussed in connection with FIG. 10, may have similar structures to that shown in FIG. 12, but omitting the radio-related circuitry and instead comprising network interface configured to communicate with other nodes in the core network, the RAN, and/or in an external data network.

The network node 1200 shown in FIG. 12 includes a processing circuitry 1202, a memory 1204, a communication interface 1206, and a power source 1208. The network node 1200 may be composed of multiple physically separate components (e.g., a NodeB component and a RNC component, or a BTS component and a BSC component, etc.), which may each have their own respective components. In certain scenarios in which the network node 1200 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1200 may be configured to support multiple radio access technologies (RATs). In such embodiments, some components may be duplicated (e.g., separate memory 1204 for different RATs) and some components may be reused (e.g., a same antenna 1210 may be shared by different RATs). The network node 1200 may also include multiple sets of the various illustrated components for different wireless technologies integrated into network node 1200, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1200.

The processing circuitry 1202 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1200 components, such as the memory 1204, to provide network node 1200 functionality.

In some embodiments, the processing circuitry 1202 includes a system on a chip (SOC). In some embodiments (e.g. where the network node 1200 is a RAN node), the processing circuitry 1202 includes one or more of radio frequency (RF) transceiver circuitry 1212 and baseband processing circuitry 1214. In some embodiments, the radio frequency (RF) transceiver circuitry 1212 and the baseband processing circuitry 1214 may be on separate chips (or sets of chips), boards, or units, such as radio units and digital units. In alternative embodiments, part or all of RF transceiver circuitry 1212 and baseband processing circuitry 1214 may be on the same chip or set of chips, boards, or units. In embodiments where the network node 1200 is a core network node, the processing circuitry 1202 does not include, or does not need to include, RF transceiver circuitry 1212 or baseband processing circuitry 1214.

The memory 1204 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1202. The memory 1204 may store any suitable instructions, data, or information, including a computer program, software, an application including one or more of logic, rules, code, tables, and/or other instructions capable of being executed by the processing circuitry 1202 and utilized by the network node 1200. The memory 1204 may be used to store any calculations made by the processing circuitry 1202 and/or any data received via the communication interface 1206. In some embodiments, the processing circuitry 1202 and memory 1204 is integrated.

The communication interface 1206 is used in wired or wireless communication of signaling and/or data between a network node, access network, and/or UE. As illustrated, the communication interface 1206 comprises port(s)/terminal(s) 1216 to send and receive data, for example to and from a network over a wired connection. The communication interface 1206 can also include, for example where the network node 1200 is a RAN node, radio front-end circuitry 1218 that may be coupled to, or in certain embodiments a part of, the antenna 1210. Radio front-end circuitry 1218 comprises filters 1220 and amplifiers 1222. The radio front-end circuitry 1218 may be connected to an antenna 1210 and processing circuitry 1202. The radio front-end circuitry may be configured to condition signals communicated between antenna 1210 and processing circuitry 1202. The radio front-end circuitry 1218 may receive digital data that is to be sent out to other network nodes or UEs via a wireless connection. The radio front-end circuitry 1218 may convert the digital data into a radio signal having the appropriate channel and bandwidth parameters using a combination of filters 1220 and/or amplifiers 1222. The radio signal may then be transmitted via the antenna 1210. Similarly, when receiving data, the antenna 1210 may collect radio signals which are then converted into digital data by the radio front-end circuitry 1218. The digital data may be passed to the processing circuitry 1202. In other embodiments, the communication interface may comprise different components and/or different combinations of components.

In certain alternative embodiments, the network node 1200 does not include separate radio front-end circuitry 1218, instead, the processing circuitry 1202 includes radio front-end circuitry and is connected to the antenna 1210. Similarly, in some embodiments, all or some of the RF transceiver circuitry 1212 is part of the communication interface 1206. In still other embodiments, the communication interface 1206 includes one or more ports or terminals 1216, the radio front-end circuitry 1218, and the RF transceiver circuitry 1212, as part of a radio unit (not shown), and the communication interface 1206 communicates with the baseband processing circuitry 1214, which is part of a digital unit (not shown).

The antenna 1210 may include one or more antennas, or antenna arrays, configured to send and/or receive wireless signals. The antenna 1210 may be coupled to the radio front-end circuitry 1218 and may be any type of antenna capable of transmitting and receiving data and/or signals wirelessly. In certain embodiments, the antenna 1210 is separate from the network node 1200 and connectable to the network node 1200 through an interface or port.

The antenna 1210, communication interface 1206, and/or the processing circuitry 1202 may be configured to perform any receiving operations and/or certain obtaining operations described herein as being performed by the network node. Any information, data and/or signals may be received from a UE, another network node and/or any other network equipment. Similarly, the antenna 1210, the communication interface 1206, and/or the processing circuitry 1202 may be configured to perform any transmitting operations described herein as being performed by the network node. Any information, data and/or signals may be transmitted to a UE, another network node and/or any other network equipment.

In embodiments where the network node 1200 is a core network node, the network node 1200 does not include, or does not need to include, antenna 1210 or RF front-end circuitry 1218.

The power source 1208 provides power to the various components of network node 1200 in a form suitable for the respective components (e.g., at a voltage and current level needed for each respective component). The power source 1208 may further comprise, or be coupled to, power management circuitry to supply the components of the network node 1200 with power for performing the functionality described herein. For example, the network node 1200 may be connectable to an external power source (e.g., the power grid, an electricity outlet) via an input circuitry or interface such as an electrical cable, whereby the external power source supplies power to power circuitry of the power source 1208. As a further example, the power source 1208 may comprise a source of power in the form of a battery or battery pack which is connected to, or integrated in, power circuitry. The battery may provide backup power should the external power source fail.

Embodiments of the network node 1200 may include additional components beyond those shown in FIG. 12 for providing certain aspects of the network node's functionality, including any of the functionality described herein and/or any functionality necessary to support the subject matter described herein. For example, the network node 1200 may include user interface equipment to allow input of information into the network node 1200 and to allow output of information from the network node 1200. This may allow a user to perform diagnostic, maintenance, repair, and other administrative functions for the network node 1200.

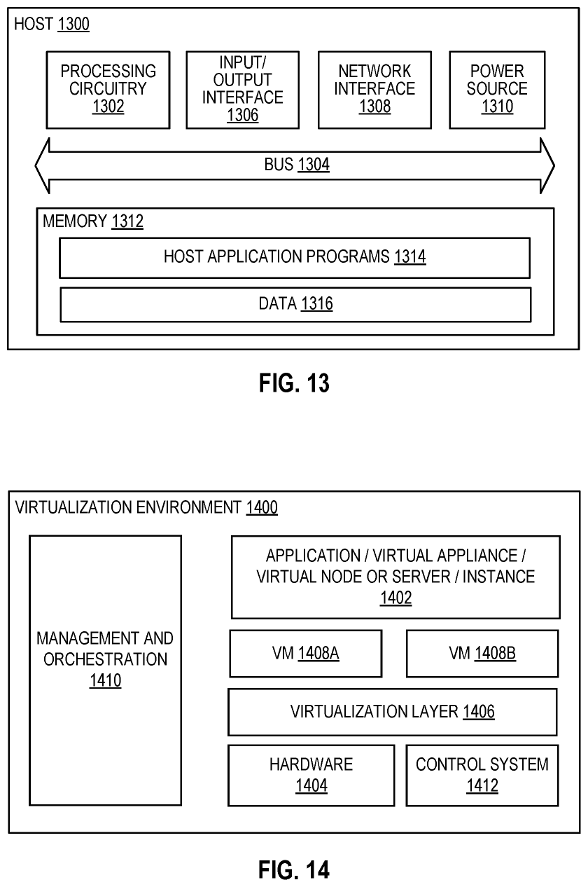

FIG. 13 is a block diagram of a host 1300, which may be an embodiment of the host 1016 of FIG. 10, in accordance with various aspects described herein. As used herein, the host 1300 may be or comprise various combinations hardware and/or software, including a standalone server, a blade server, a cloud-implemented server, a distributed server, a virtual machine, container, or processing resources in a server farm. The host 1300 may provide one or more services to one or more UEs.

The host 1300 includes processing circuitry 1302 that is operatively coupled via a bus 1304 to an input/output interface 1306, a network interface 1308, a power source 1310, and a memory 1312. Other components may be included in other embodiments. Features of these components may be substantially similar to those described with respect to the devices of previous figures, such as FIGS. 11 and 12, such that the descriptions thereof are generally applicable to the corresponding components of host 1300.

The memory 1312 may include one or more computer programs including one or more host application programs 1314 and data 1316, which may include user data, e.g., data generated by a UE for the host 1300 or data generated by the host 1300 for a UE. Embodiments of the host 1300 may utilize only a subset or all of the components shown. The host application programs 1314 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1314 may also provide for user authentication and licensing checks and may periodically report health, routes, and content availability to a central node, such as a device in or on the edge of a core network. Accordingly, the host 1300 may select and/or indicate a different host for over-the-top services for a UE. The host application programs 1314 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 14 is a block diagram illustrating a virtualization environment 1400 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1400 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 1400 may implement any of the NFs described herein, e.g. any one or more of the UDM, UDR, AF, NRF, and NEF.

Applications 1402 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1404 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1406 (also referred to as hypervisors or virtual machine monitors (VMMs)), provide VMs 1408a and 1408b (one or more of which may be generally referred to as VMs 1408), and/or perform any of the functions, features and/or benefits described in relation with some embodiments described herein. The virtualization layer 1406 may present a virtual operating platform that appears like networking hardware to the VMs 1408.

The VMs 1408 comprise virtual processing, virtual memory, virtual networking or interface and virtual storage, and may be run by a corresponding virtualization layer 1406. Different embodiments of the instance of a virtual appliance 1402 may be implemented on one or more of VMs 1408, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1408 may be a software implementation of a physical machine that runs programs as if they were executing on a physical, non-virtualized machine. Each of the VMs 1408, and that part of hardware 1404 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1408 on top of the hardware 1404 and corresponds to the application 1402.

Hardware 1404 may be implemented in a standalone network node with generic or specific components. Hardware 1404 may implement some functions via virtualization. Alternatively, hardware 1404 may be part of a larger cluster of hardware (e.g. such as in a data center or CPE) where many hardware nodes work together and are managed via management and orchestration 1410, which, among others, oversees lifecycle management of applications 1402. In some embodiments, hardware 1404 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1412 which may alternatively be used for communication between hardware nodes and radio units.

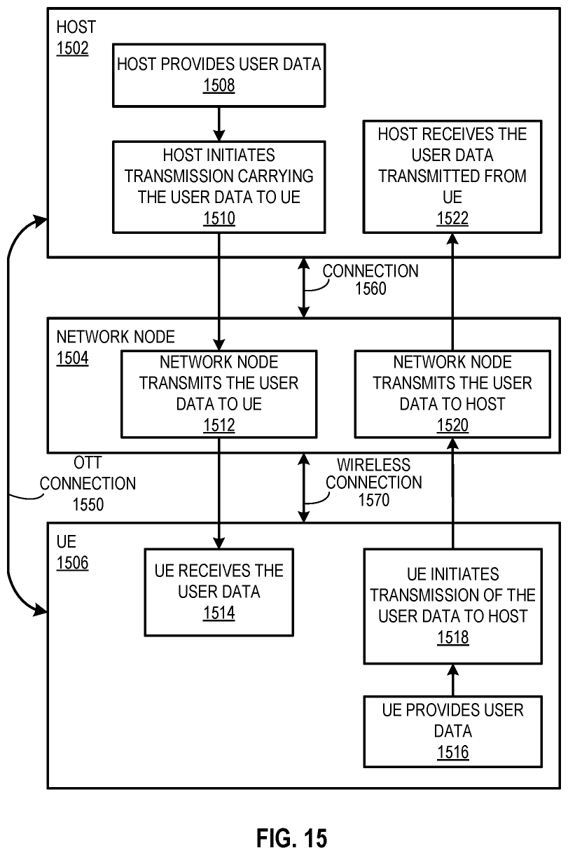

FIG. 15 shows a communication diagram of a host 1502 communicating via a network node 1504 with a UE 1506 over a partially wireless connection in accordance with some embodiments. Example implementations, in accordance with various embodiments, of the UE (such as a UE 1012a of FIG. 10 and/or UE 1100 of FIG. 11), network node (such as network node 1010a of FIG. 10 and/or network node 1200 of FIG. 12), and host (such as host 1016 of FIG. 10 and/or host 1300 of FIG. 13) discussed in the preceding paragraphs will now be described with reference to FIG. 15.

Like host 1300, embodiments of host 1502 include hardware, such as a communication interface, processing circuitry, and memory. The host 1502 also includes software, which is stored in or accessible by the host 1502 and executable by the processing circuitry. The software includes a host application that may be operable to provide a service to a remote user, such as the UE 1506 connecting via an over-the-top (OTT) connection 1550 extending between the UE 1506 and host 1502. In providing the service to the remote user, a host application may provide user data which is transmitted using the OTT connection 1550.

The network node 1504 includes hardware enabling it to communicate with the host 1502 and UE 1506. The connection 1560 may be direct or pass through a core network (like core network 1006 of FIG. 10) and/or one or more other intermediate networks, such as one or more public, private, or hosted networks. For example, an intermediate network may be a backbone network or the Internet.

The UE 1506 includes hardware and software, which is stored in or accessible by UE 1506 and executable by the UE's processing circuitry. The software includes a client application, such as a web browser or operator-specific “app” that may be operable to provide a service to a human or non-human user via UE 1506 with the support of the host 1502. In the host 1502, an executing host application may communicate with the executing client application via the OTT connection 1550 terminating at the UE 1506 and host 1502. In providing the service to the user, the UE's client application may receive request data from the host's host application and provide user data in response to the request data. The OTT connection 1550 may transfer both the request data and the user data. The UE's client application may interact with the user to generate the user data that it provides to the host application through the OTT connection 1550.

The OTT connection 1550 may extend via a connection 1560 between the host 1502 and the network node 1504 and via a wireless connection 1570 between the network node 1504 and the UE 1506 to provide the connection between the host 1502 and the UE 1506. The connection 1560 and wireless connection 1570, over which the OTT connection 1550 may be provided, have been drawn abstractly to illustrate the communication between the host 1502 and the UE 1506 via the network node 1504, without explicit reference to any intermediary devices and the precise routing of messages via these devices.

As an example of transmitting data via the OTT connection 1550, in step 1508, the host 1502 provides user data, which may be performed by executing a host application. In some embodiments, the user data is associated with a particular human user interacting with the UE 1506. In other embodiments, the user data is associated with a UE 1506 that shares data with the host 1502 without explicit human interaction. In step 1510, the host 1502 initiates a transmission carrying the user data towards the UE 1506. The host 1502 may initiate the transmission responsive to a request transmitted by the UE 1506. The request may be caused by human interaction with the UE 1506 or by operation of the client application executing on the UE 1506. The transmission may pass via the network node 1504, in accordance with the teachings of the embodiments described throughout this disclosure. Accordingly, in step 1512, the network node 1504 transmits to the UE 1506 the user data that was carried in the transmission that the host 1502 initiated, in accordance with the teachings of the embodiments described throughout this disclosure. In step 1514, the UE 1506 receives the user data carried in the transmission, which may be performed by a client application executed on the UE 1506 associated with the host application executed by the host 1502.

In some examples, the UE 1506 executes a client application which provides user data to the host 1502. The user data may be provided in reaction or response to the data received from the host 1502. Accordingly, in step 1516, the UE 1506 may provide user data, which may be performed by executing the client application. In providing the user data, the client application may further consider user input received from the user via an input/output interface of the UE 1506. Regardless of the specific manner in which the user data was provided, the UE 1506 initiates, in step 1518, transmission of the user data towards the host 1502 via the network node 1504. In step 1520, in accordance with the teachings of the embodiments described throughout this disclosure, the network node 1504 receives user data from the UE 1506 and initiates transmission of the received user data towards the host 1502. In step 1522, the host 1502 receives the user data carried in the transmission initiated by the UE 1506.

One or more of the various embodiments may improve the performance of OTT services provided to the UE 1506 using the OTT connection 1550, in which the wireless connection 1570 forms the last segment. More precisely, the teachings of these embodiments may improve the network's ability to self-optimize its performance and/or allow network performance to be optimized to support and/or prioritize a particular service provided to one or more UEs and/or applications and thereby provide benefits such as improved network speed, reliability, power efficiency, and the like.

In an example scenario, factory status information may be collected and analyzed by the host 1502. As another example, the host 1502 may process audio and video data which may have been retrieved from a UE for use in creating maps. As another example, the host 1502 may collect and analyze real-time data to assist in controlling vehicle congestion (e.g., controlling traffic lights). As another example, the host 1502 may store surveillance video uploaded by a UE. As another example, the host 1502 may store or control access to media content such as video, audio, VR or AR which it can broadcast, multicast or unicast to UEs. As other examples, the host 1502 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1550 between the host 1502 and UE 1506, in response to variations in the measurement results. The measurement procedure and/or the network functionality for reconfiguring the OTT connection may be implemented in software and hardware of the host 1502 and/or UE 1506. In some embodiments, sensors (not shown) may be deployed in or in association with other devices through which the OTT connection 1550 passes; the sensors may participate in the measurement procedure by supplying values of the monitored quantities exemplified above, or supplying values of other physical quantities from which software may compute or estimate the monitored quantities. The reconfiguring of the OTT connection 1550 may include message format, retransmission settings, preferred routing etc.; the reconfiguring need not directly alter the operation of the network node 1504. Such procedures and functionalities may be known and practiced in the art. In certain embodiments, measurements may involve proprietary UE signaling that facilitates measurements of throughput, propagation times, latency and the like, by the host 1502. The measurements may be implemented in that software causes messages to be transmitted, in particular empty or ‘dummy’ messages, using the OTT connection 1550 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### Example Embodiments

Embodiments of the techniques, apparatuses, and systems described herein include, but are not limited to, the following enumerated examples:
1. A method, in a network exposure function, NEF, configured to expose services of a wireless network to one or more application function, AFs, wherein the wireless network comprises a plurality of unified data management functions, UDMs, and a plurality of Unified Data Repositories, UDRs, the method comprising:
   discovering one or more UDMs that support centralized storage of any-UE-data related to a network service, wherein any-UE-data is data relating to service requests for the network service for all user equipments, UEs, in the wireless network; and
   responsive to discovering the one or more UDMs, sending, to only one UDM among the discovered UDMs that support centralized storage of any-UE-data related to the network service, a request for subscription to the network service.
2. The method of example embodiment 1, wherein the method further comprises discovering at least one UDR that is configured for centralized storage of any-UE-data for the network service, and wherein said sending is responsive to discovering the one or more UDMs and the at least one UDR.
3. The method of example embodiment 2, wherein discovering at least one UDR that is configured for centralized storage of any-UE-data comprises sending, to a network repository function, NRF, a discovery request message comprising a parameter, specific to the network service, indicating a request for a centralized any-UE-data storage feature for the network service.
4. The method of example embodiment 2 or 3, wherein discovering at least one UDR that is configured for centralized storage of any-UE-data comprises evaluating a locally-stored set of profiles for UDRs in the network to identify one or more UDRs configured for centralized storage of any-UE-data related to the network service.
5. The method of any one of example embodiments 1-4, wherein the network service is an event exposure service and the request for a subscription to the network service is for all UEs in the wireless network.
6. The method of any one of example embodiments 1-5, wherein discovering one or more UDMs that support centralized storage of any-UE-data related to the network service comprises sending, to a network repository function, NRF, a discovery request message comprising a parameter, specific to the network service, indicating a request for a centralized any-UE-data management feature for the network service.
7. The method of any one of example embodiments 1-5, wherein discovering one or more UDMs that support centralized storage of any-UE-data related to the network service comprises evaluating a locally-stored set of profiles for UDMs in the network to identify one or more UDMs that support centralized storage of any-UE-data related to the network service.
8. The method of any of example embodiments 1-7, further comprising selecting the only one UDM based on locations of the discovered UDMs and/or based on predetermined prioritizations of the discovered UDMs.
9. The method of any of example embodiments 1-8, wherein the method further comprises:
   determining that the network includes one or more UDM groups that include no UDMs supporting centralized storage of any-UE-data related to the network service; and
   sending, to at least one UDM in each of the one or more UDM groups that include no UDMs supporting centralized storage of any-UE-data related to the network service, a request for subscription to the network service.
10. A method, in a network repository function, NRF, configured to provide service registration in a wireless network, wherein the wireless network comprises a plurality of unified data management functions, UDMs, and a plurality of Unified Data Repositories, UDRs, the method comprising:
   receiving, from a network exposure function, NEF, configured to expose services of the wireless network to one or more application function, AFs, a discovery request message for UDMs that support centralized storage of any-UE-data related to a network service, wherein any-UE-data is data relating to service requests for the network service for all user equipments, UEs, in the wireless network;
   identifying one or more UDMs that support centralized storage of any-UE-data related to that network service; and
   responding to the NEF with a message indicating the identified one or more UDMs.
11. The method of example embodiment 10, further comprising:
receiving, from the NEF, a discovery request message for at least one UDR that is configured for centralized storage of any-UE-data related to the network service;
identifying at least one UDR that supports centralized storage of any-UE-data related to that network service; and
responding to the NEF with a message indicating the identified at least one UDR.
12. The method of example embodiment 10 or 11, further comprising:
receiving, prior to receiving said discovery request message(s), a registration message from each of one or more UDMs and/or UDRs that support centralized storage of any-UE-data related to the network service, each registration message indicating the support of centralized storage of any-UE-data related to the network service.
13. The method of any one of example embodiments 10-12, wherein the network service is an event exposure service.
14. A method, in a unified data management function, UDM, in a wireless network having a network exposure function, NEF, configured to expose services of the wireless network to one or more application function, AFs, wherein the wireless network comprises a plurality of UDMs and a plurality of unified data repositories, UDRs, the method comprising:
   sending, to a Network Repository Function, a registration message indicating, for each of one or more network services, the support of centralized storage of any-UE-data related to the network service, wherein any-UE-data is data relating to service requests for the network service for all user equipments, UEs, in the wireless network.
15. The method of example embodiment 14, wherein the one or more network services comprise any one or more of: an event exposure service, a parameter provisioning service, and a service parameter service.
16. A method, in a unified data repository, UDR, in a wireless network having a network exposure function, NEF, configured to expose services of the wireless network to one or more application function, AFs, wherein the network comprises a plurality of unified data management functions, UDMs and a plurality of UDRs, the method comprising:
   sending, to a Network Repository Function, a registration message indicating, for each of one or more network services, the support of centralized storage of any-UE-data related to the network service, wherein any-UE-data is data relating to service requests for the network service for all user equipments, UEs, in the wireless network.
17. The method of example embodiment 16, wherein the one or more network services comprise any one or more of: an event exposure service, a parameter provisioning service, and a service parameter service.
18. A network node or combination of network nodes configured to act as a network exposure function, NEF, and thus to expose services of a wireless network to one or more application function, AFs, in a wireless network, wherein the wireless network comprises a plurality of unified data management functions, UDMs, and a plurality of Unified Data Repositories, UDRs, wherein the network node or combination of network nodes is adapted to carry out a method according to any one of example embodiments 1-9.
19. A network node or combination of network nodes configured to act as a network exposure function, NEF, and thus to expose services of a wireless network to one or more application function, AFs, in a wireless network, wherein the wireless network comprises a plurality of unified data management functions, UDMs, and a plurality of Unified Data Repositories, UDRs, the network node or combination of network nodes comprising at least one processing circuit, the at least one processing circuit being configured to:
   discover one or more UDMs that support centralized storage of any-UE-data related to a network service, wherein any-UE-data is data relating to service requests for the network service for all user equipments, UEs, in the wireless network; and
   responsive to discovering the one or more UDMs, send, to only one UDM among the discovered UDMs that support centralized storage of any-UE-data related to the network service, a request for subscription to the network service.
20. The network node or combination of network nodes of example embodiment 19, wherein the at least one processing circuit is further configured to discover at least one UDR that is configured for centralized storage of any-UE-data for the network service and to send the request responsive to discovering the one or more UDMs and the at least one UDR.
21. The network node or combination of network nodes of example embodiment 19 or 20, wherein the at least one processing circuit is further configured to carry out a method according to any of example embodiments 3-9.
22. A network node or combination of network nodes configured to act as a network repository function, NRF, configured to provide service registration in a wireless network, where the wireless network comprises a plurality of unified data management functions, UDMs, and a plurality of Unified Data Repositories, UDRs, wherein the network node or combination of network nodes is adapted to carry out a method according to any one of example embodiments 10-13.
23. A network node or combination of network nodes configured to act as a network repository function, NRF, configured to provide service registration in a wireless network, where the wireless network comprises a plurality of unified data management functions, UDMs, and a plurality of Unified Data Repositories, UDRs, the network node or combination of network nodes comprising at least one processing circuit, the at least one processing circuit being configured to:
   receive, from a network exposure function, NEF, configured to expose services of the wireless network to one or more application function, AFs, a discovery request message for UDMs that support centralized storage of any-UE-data related to a network service, wherein any-UE-data is data relating to service requests for the network service for all user equipments, UEs, in the wireless network;
   identify one or more UDMs that support centralized storage of any-UE-data related to that network service; and
   respond to the NEF with a message indicating the identified one or more UDMs.
24. A network node or combination of network nodes configured to operate as a unified data management function, UDM, in a wireless network having a network exposure function, NEF, configured to expose services of the wireless network to one or more application function, AFs, wherein the wireless network comprises a plurality of UDMs and a plurality of unified data repositories, UDRs, wherein the network node or combination of network nodes is adapted to carry out a method according to example embodiment 14 or 15.
25. A network node or combination of network nodes configured to operate as a unified data management function, UDM, in a wireless network having a network exposure function, NEF, configured to expose services of the wireless network to one or more application function, AFs, wherein the wireless network comprises a plurality of UDMs and a plurality of unified data repositories, UDRs, the network node or combination of network nodes comprising at least one processing circuit, the at least one processing circuit being configured to:
   send, to a Network Repository Function, a registration message indicating, for each of one or more network services, the support of centralized storage of any-UE-data related to the network service, wherein any-UE-data is data relating to service requests for the network service for all user equipments, UEs, in the wireless network.
26. A network node or combination of network nodes configured to operate as a unified data repository, UDR, in a wireless network having a network exposure function, NEF, configured to expose services of the wireless network to one or more application function, AFs, wherein the network comprises a plurality of unified data management functions, UDMs and a plurality of UDRs, wherein the network node or combination of network nodes is adapted to carry out a method according to example embodiment 16 or 17.
27. A network node or combination of network nodes configured to operate as a unified data repository, UDR, in a wireless network having a network exposure function, NEF, configured to expose services of the wireless network to one or more application function, AFs, wherein the network comprises a plurality of unified data management functions, UDMs and a plurality of UDRs s, the network node or combination of network nodes comprising at least one processing circuit, the at least one processing circuit being configured to:
   send, to a Network Repository Function, a registration message indicating, for each of one or more network services, the support of centralized storage of any-UE-data related to the network service, wherein any-UE-data is data relating to service requests for the network service for all user equipments, UEs, in the wireless network.
28. A computer program product comprising program instructions for execution by a processing circuit in a network node or combination of network nodes, the program instructions being configured to cause the network node or combination of network nodes to carry out a method according to any one of example embodiments 1-18.
29. A computer-readable medium, such as a non-transitory computer-readable medium, comprising the computer program product of example embodiment 28.

1. A method, in a network exposure function, NEF, configured to expose services of a wireless network to one or more application functions, AFs, the method comprising:
discovering, in the wireless network, one or more unified data management functions, UDMs, that support centralized storage of any-UE-data related to a network service, the any-UE-data being data relating to service requests for the network service for all user equipments, UEs, in the wireless network; and
responsive to discovering the one or more UDMs, sending, to only one UDM among the discovered UDMs that support centralized storage of any-UE-data related to the network service, a request for subscription to the network service.

2. The method of claim 1, wherein the method further comprises evaluating a locally-stored set of profiles for unified data repositories, UDRs in the network to identify one or more UDRs configured for centralized storage of any-UE-data related to the network service.

3. The method of claim 1, wherein the method further comprises discovering, in the wireless network, at least one unified data repository, UDR, that is configured for centralized storage of any-UE-data for the network service, and wherein said sending is responsive to discovering the one or more UDMs and the at least one UDR.

4. The method of claim 3, wherein discovering at least one UDR that is configured for centralized storage of any-UE-data comprises sending, to a network repository function, NRF, a discovery request message comprising a parameter, specific to the network service, indicating a request for a centralized any-UE-data storage feature for the network service.

5. The method of claim 1, wherein if one or more UDMs are discovered as supporting centralized storage of any-UE-data related to a network service, the NEF determines that there is at least one UDR in the wireless network that is configured for centralized storage of any-UE-data related to the network service.

6. The method of claim 1, wherein the network service is an event exposure service and the request for a subscription to the network service is for all UEs in the wireless network.

7. The method of claim 1, wherein discovering, in the wireless network, one or more UDMs that support centralized storage of any-UE-data related to the network service comprises sending, to a network repository function, NRF, a discovery request message comprising a parameter, specific to the network service, indicating a request for a centralized any-UE-data management feature for the network service.

8. The method of claim 1, wherein discovering, in the wireless network, one or more UDMs that support centralized storage of any-UE-data related to the network service comprises evaluating a locally-stored set of profiles for UDMs in the network to identify one or more UDMs that support centralized storage of any-UE-data related to the network service.

9. The method of claim 1, further comprising selecting the only one UDM based on one or both of locations of the discovered UDMs and predetermined prioritizations of the discovered UDMs.

10. A method, in a network repository function, NRF, configured to provide service registration in a wireless network, the method comprising:
receiving, from a network exposure function, NEF, configured to expose services of the wireless network to one or more application functions, AFs, a discovery request message for unified data management functions, UDMs, in the wireless network that support centralized storage of any-UE-data related to a network service, the any-UE-data being data relating to service requests for the network service for all user equipments, UEs, in the wireless network;
identifying one or more UDMs that support centralized storage of any-UE-data related to that network service; and
responding to the NEF with a message indicating the identified one or more UDMs.

11. The method of claim 10, further comprising:
receiving, from the NEF, a discovery request message for at least one unified data repository, UDR, in the wireless network that is configured for centralized storage of any-UE-data related to the network service;
identifying at least one UDR that supports centralized storage of any-UE-data related to that network service; and
responding to the NEF with a message indicating the identified at least one UDR.

12. The method of claim 10, further comprising:
receiving, prior to receiving said discovery request message(s), a registration message from each of one or both of one or more UDMs and UDRs that support centralized storage of any-UE-data related to the network service, each registration message indicating the support of centralized storage of any-UE-data related to the network service.

13. The method of claim 10, wherein the network service is an event exposure service.

14. The method of claim 10, wherein the discovery request message comprises a parameter, specific to the network service, indicating a request for a centralized any-UE-data management feature for the network service.

15-22. (canceled)

23. A network node or combination of network nodes configured to act as a network exposure function, NEF, to expose services of a wireless network to one or more application functions, AFs, in a wireless network, the network node or combination of network nodes comprising at least one processing circuit and a memory, the memory containing instructions executable by the at least one processing circuit whereby the at least one processing circuit is operative to:
discover, in the wireless network, one or more unified data management functions, UDMs, that support centralized storage of any-UE-data related to a network service, the any-UE-data being data relating to service requests for the network service for all user equipments, UEs, in the wireless network; and
responsive to discovering the one or more UDMs, send, to only one UDM among the discovered UDMs that support centralized storage of any-UE-data related to the network service, a request for subscription to the network service.

24. The network node or combination of network nodes of claim 23, wherein the at least one processing circuit is further operative to evaluate a locally-stored set of profiles for unified data repositories, UDRs in the network to identify one or more UDRs configured for centralized storage of any-UE-data related to the network service.

25. (canceled)

26. A network node or combination of network nodes configured to act as a network repository function, NRF, configured to provide service registration in a wireless network, the network node or combination of network nodes comprising at least one processing circuit and a memory, the memory containing instructions executable by the at least one processing circuit whereby the at least one processing circuit is operative to:
receive, from a network exposure function, NEF, configured to expose services of the wireless network to one or more application functions, AFs, a discovery request message for UDMs in the wireless network that support centralized storage of any-UE-data related to a network service, the any-UE-data being data relating to service requests for the network service for all user equipments, UEs, in the wireless network;
identify one or more UDMs that support centralized storage of any-UE-data related to that network service; and
respond to the NEF with a message indicating the identified one or more UDMs.

27-32. (canceled)

33. The method of claim 2, wherein the method further comprises discovering, in the wireless network, at least one unified data repository, UDR, that is configured for centralized storage of any-UE-data for the network service, and wherein said sending is responsive to discovering the one or more UDMs and the at least one UDR.

34. The method of claim 33, wherein discovering at least one UDR that is configured for centralized storage of any-UE-data comprises sending, to a network repository function, NRF, a discovery request message comprising a parameter, specific to the network service, indicating a request for a centralized any-UE-data storage feature for the network service.

35. The network node or combination of network nodes of claim 17, wherein the at least one processing circuit is further operative to:
receive, from the NEF, a discovery request message for at least one unified data repository, UDR, in the wireless network that is configured for centralized storage of any-UE-data related to the network service;
identify at least one UDR that supports centralized storage of any-UE-data related to that network service; and
respond to the NEF with a message indicating the identified at least one UDR.
